(19) United States
(12) Patent Application Publication
(10) Pub. No.: US 2012/0226568 A1
(43) Pub. Date: Sep. 6, 2012

(54) Bar Bandit

(76) Inventors: Ryan E. Hargraves, Charlottesville, VA (US); Stephen J. McNaughton, Charlottesville, VA (US)

(21) Appl. No.: 13/037,417

(22) Filed: Mar. 1, 2011

(51) Int. Cl. G06Q 30/00

(52) U.S. Cl. 705/26.1; 705/1.1

(57) ABSTRACT

A method and system for streamlining the customer experience at a live event or in a bar/restaurant setting thru the use of an electronic device; the process may include the use of a chip embedded in/bar code imprinted on a bracelet worn by the customer or displayed on an electronic device. When seating is limited, this check-in process will also allow the customer to reserve the next available table. The vendor can page each checked-in guest via the Bar Bandit system when their table becomes available; this will eliminate the need for a physical restaurant pager. The Bar Bandit system will allow the acceleration of any portion of the client service experience; this may include any of the following: interaction w/the ordering system, payment processing & paging the server.

A method and system for streamlining the customer experience in a bar and/or restaurant setting thru the use of the Internet and a smart phone application; this process may include the use of a bar code imprinted/embedded in a bracelet worn by the customer or represented on the display of a standard phone or smart phone. Upon arrival the customer will go through a standardized check-in process by presenting his unique ID which may be validated via barcode or wireless chip; the barcode may be displayed physically (imprinted or embedded) on an accessory or displayed electronically on a phone/smart phone. The server system receives customer information including identification of the customer, payment information and assigns a customer number for the current unique visit. Once assigned a customer number, the customer may electronically order appetizers, drinks or any other menu item that the vendor has decided to make available via the Bar Bandit system. In a restaurant setting where seating is limited, this check-in process will also allow the customer to reserve the next available table (see FIG. 1). The vendor can page each checked-in guest via the Bar Bandit system when their table becomes available; this will eliminate the need for a physical restaurant pager.

Once seated, the Bar Bandit system will allow the customer to accelerate any portion of the client service experience that the vendor has enabled. This may include any of the following: 1. direct communication w/the bar or restaurant ordering system. 2. payment processing (for the purchase of menu items as well as the closing of a tab or settling the bill for a meal); this can be done manually by clicking a button w/in the application or automatically based upon the location of the bracelet or phone/smart phone device in relation to the bar/restaurant's server network. 3. Paging the server for any and all value-add items and/or issues not necessary on the menu including, but not limited to beverage refill, napkins, condiments, food quality, et cetera (see FIG. 2).

### BRIEF DESCRIPTION OF THE DRAWINGS

In order to understand the invention and to see how it might be carried out in practice, embodiments will now be described, by way of non-limiting example only, with reference to the accompanying drawings in which:

FIG. 1: is meant to illustrate how the customer service interaction will be streamlined in a restaurant setting; it also highlights how this system will make such an experience fully interactive.

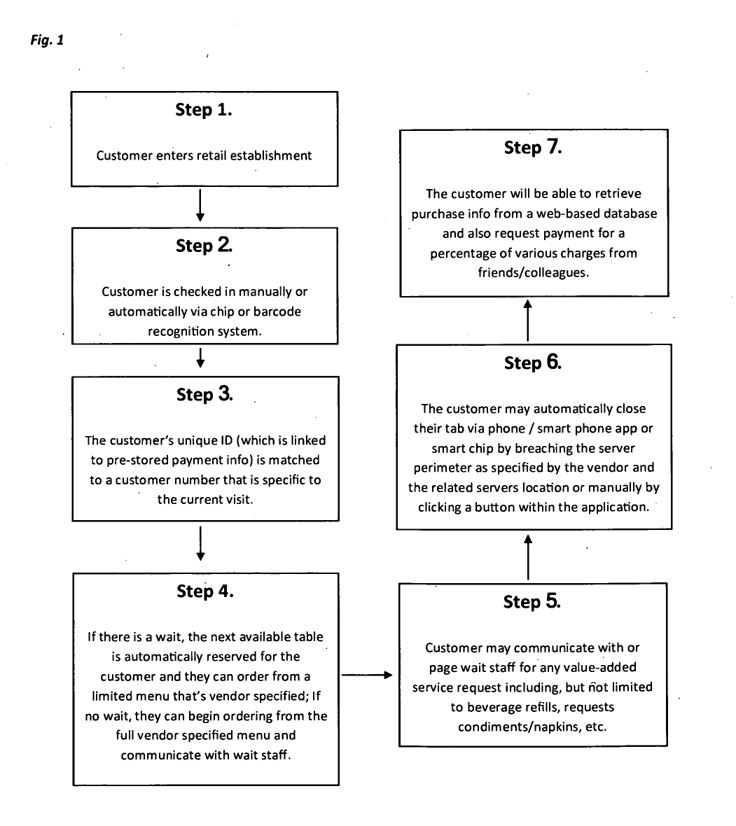

FIG. 2: is meant to illustrate the customer interface and how it might look on an electronic device. It also reflects the options that will be available to them through the Bar Bandit service; these options will be customized to the specifications requested by each venue.

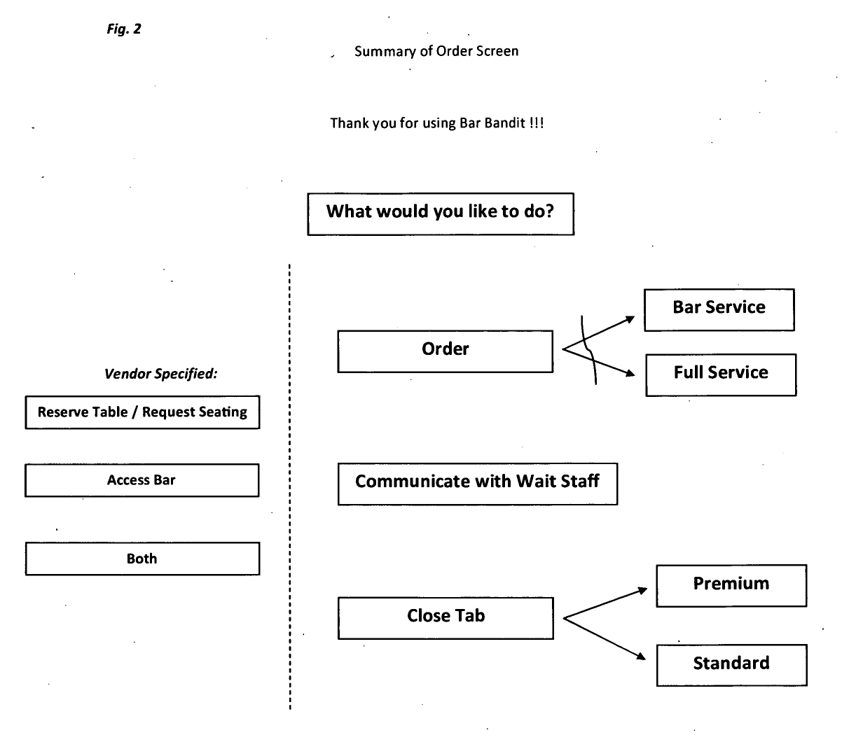

FIG. 3: is meant to illustrate some of the details that will be available to the vendor via the in-house Bar Bandit system. It will basically reflect pertinent details that allow the server to turn a normally reactive client service experience into a proactive one.

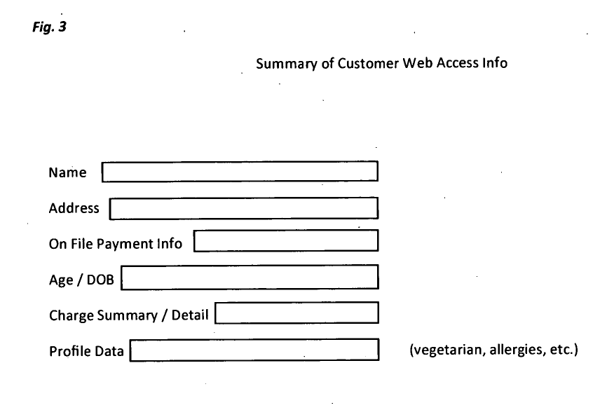

1. A method for streamlining & making the retail experience interactive in real-time.
a) ability to page & interact with wait staff at a restaurant, employees at a supermarket or concert/sports venue; purchase & order specific items without actually talking to staff/employee.
b) ability to do so via portable device (smart device or bracelet), built-in device at a centralized kiosk or located at the consumer's seat.
c) ability to extend interactivity to shared consumers e.g. a group of people goes to dinner and wants to split the check the next day after leaving the venue or one individual wants to pick-up the entire tab; should also include the ability of one individual meeting a group for dinner & running late to order prior to their ultimate arrival.
d) ability to open & close the bill/tab based on proximity to the venue.

2. A method for storing consumer preferences w/regard to payment, dietary concerns, favorite meals or regularly ordered items.
a) ability of vendor to mine this information with regard to reservations to determine what they should stock or not stock based on the profiles of those that have bought tickets or made reservations; data provided to vendor will not be tied to specific individuals for privacy concerns, but the consumer could waive anonymity.
b) ability of consumer to make special requests prior to arrival.
c) ability to extend interactivity to shared consumers e.g. a group of people goes to dinner and wants to split the check the next day after leaving the venue or one individual wants to pick-up the entire tab;

3. A method for linking a streamlined and interactive retail experience to a unique identifier (numerical & digital).
a) ability to standardize the retail experience so that consumers can customize their experience regardless of venue based on their preferences.
b) ability to provide a turnkey solution (closed loop) to the consumer experience from reservation/ticket purchase to closing the tab/exit from the venue.
